(19) United States
(12) Patent Application Publication
(10) Pub. No.: US 2024/0378351 A1
(43) Pub. Date: Nov. 14, 2024

(54) SYSTEM AND METHOD FOR SHAPE OPTIMIZATION

(71) Applicant: Toyota Research Institute, Inc., Los Altos, CA (US)

(72) Inventors: Chenyang Yuan, Cambridge, MA (US); Nikos Arechiga Gonzalez, San Mateo, CA (US); Frank Permenter, Cambridge, MA (US)

(73) Assignees: Toyota Research Institute, Inc., Los Altos, CA (US); Toyota Jidosha Kabushiki Kaisha, Toyota-Shi (JP)

(21) Appl. No.: 18/451,222

(22) Filed: Aug. 17, 2023

Related U.S. Application Data
(60) Provisional application No. 63/465,613, filed on May 11, 2023.
(60) Provisional application No. 63/471,389, filed on Jun. 6, 2023.

(51) Int. Cl. G06F 30/27; G06F 30/15

(52) U.S. Cl. CPC G06F 30/27; G06F 30/15; G06F 2111/04

(57) ABSTRACT

Systems, methods, and other embodiments described herein relate to shape optimization using a diffusion model. In one embodiment, a method includes optimizing a parameter of a shape in an image based on a predetermined constraint using a diffusion model. The parameter is a pixel value for each pixel forming the shape.

### CROSS-REFERENCE TO RELATED APPLICATION

This application claims priority to U.S. Provisional Patent Application No. 63/465,613 filed May 11, 2023, and U.S. Provisional Patent Application No. 63/471,389 filed Jun. 6, 2023, the contents of both are hereby incorporated by reference in their entirety.

### TECHNICAL FIELD

The subject matter described herein relates, in general, to systems and methods for shape optimization.

### BACKGROUND

Shape optimization and topology optimization methods that utilize computer-aided design (CAD) software are limited by the manner in which the CAD software identifies, represents and/or alters structures.

### SUMMARY

In one embodiment, a system for shape optimization using a diffusion model is disclosed. The system includes a processor and a memory in communication with the processor. The memory stores machine-readable instructions that, when executed by the processor, cause the processor to optimize a parameter of a shape in an image based on a predetermined constraint using a diffusion model. The parameter is a pixel value for each pixel forming the shape.

In another embodiment, a method for shape optimization using a diffusion model is disclosed. The method includes optimizing a parameter of a shape in an image based on a predetermined constraint using a diffusion model. The parameter is a pixel value for each pixel forming the shape.

In another embodiment, a non-transitory computer-readable medium for shape optimization using a diffusion model is disclosed. The non-transitory computer-readable medium includes instructions that, when executed by a processor, cause the processor to optimize a parameter of a shape in an image based on a predetermined constraint using a diffusion model. The parameter is a pixel value for each pixel forming the shape.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIGS. 1A-1B illustrate a data flow of a shape optimization system.

FIG. 2 illustrates one embodiment of the shape optimization system.

FIG. 3 is a flowchart illustrating one embodiment of a method associated with shape optimization.

### DETAILED DESCRIPTION

Systems, methods, and other embodiments associated with systems and methods for shape optimization are disclosed. Shape optimization in engineering design attempts to determine an optimal component shape with respect to a cost function while satisfying constraints. Shape optimization may include topology optimization, which may provide an optimal material distribution layout for a set of constraints. As such, in this invention, shape includes topology.

Current methods of shape optimization express the shape as a set of parameters such as splines, curves, and/or control points of curves, and then optimize the shape based on that set of parameters. Parameters, in general, may be used to describe the characteristics of the shape. As an example, the parameters of a bridge may include the points where the bridge connects to land and the positions of the trusses of the bridge. However, shape optimization based on parameters that describe the shape in terms of curves, lines, and positioning may be limited, may not be precise, and may result in non-feasible designs. Certain computer-aided design systems are limited to expressing the shape in terms of curves, lines, and positioning.

Accordingly, systems, methods, and other embodiments associated with shape optimization are disclosed. As an example, the method includes expressing the shape using pixels and pixel values as the parameters. The system receives an image such as a vehicle and a predetermined constraint such as an engineering constraint, e.g., a drag coefficient, a dimensional constraint, or a vehicle weight distribution ratio. The system feeds the image and the predetermined constraint to a diffusion model. The diffusion model identifies the image in terms of the pixels and the pixel values. The diffusion model is trained on real images as a regularizer. As such, the diffusion model may alter one or more pixel values, e.g., turning on or turning off a pixel, such that the image is closer to meeting or satisfying the predetermined constraint, and then the diffusion model may constrain the resulting image to look like a real image. The diffusion model may incrementally alter the image and cycle through multiple iterations until the diffusion model determines that the image meets the predetermined constraints.

The embodiments disclosed herein present various advantages over conventional technologies that perform shape optimization. First, the embodiments are able to produce real shapes and images that satisfy engineering constraints. Second, the embodiments generate a more precise shape optimization. Third, the embodiments assist designers and engineers in altering an existing design to improve performance metrics using the diffusion model as a projection operator.

Detailed embodiments are disclosed herein; however, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in the figures, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

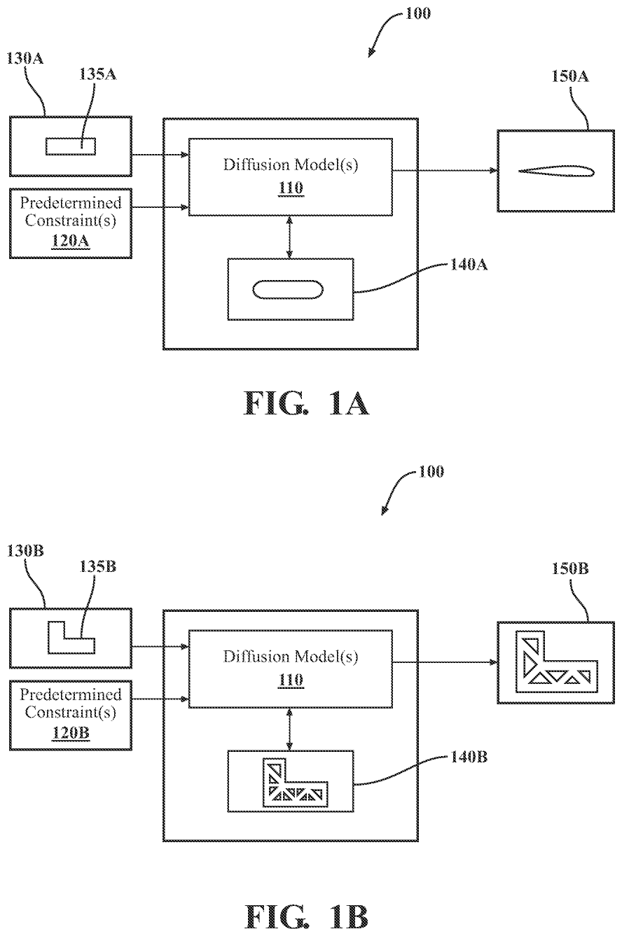

FIGS. 1A-1B illustrate a data flow of a shape optimization system 100. The shape optimization system 100 may include various elements, which may be communicatively linked in any suitable form. As an example, the elements may be connected, as shown in FIG. 1. Some of the possible elements of the shape optimization system 100 are shown in FIG. 1 and will now be described. It will be understood that it is not necessary for the shape optimization system 100 to have all the elements shown in FIG. 1 or described herein. The shape optimization system 100 may have any combination of the various elements shown in FIG. 1. Further, the shape optimization system 100 may have additional elements to those shown in FIG. 1. In some arrangements, the shape optimization system 100 may not include one or more of the elements shown in FIG. 1.

The shape optimization system 100 includes one or more diffusion models 110. The diffusion model(s) 110 may be any suitable machine learning models. The diffusion model 110 is a generative model. As such, the diffusion model 110 may also be referred to as a diffusion-based generative model. Generative models are a class of machine learning models that can generate new data based on training data. As an example, the diffusion model 110 is capable of generating images such as high-resolution images. Further, the diffusion model 110 is capable of receiving an image and altering the parameters (or characteristics) of the image.

In general, the diffusion model 110 receives an initial image 130A, 130B (collectively known as 130) as a reference image and one or more predetermined constraints 120A, 120B (collectively known as 120). The diffusion model 110 then alters the initial image 130 to meet the predetermined constraints 120. The diffusion model 110 may incrementally alter the initial image 130, resulting in one or more intermediate images 140A, 140B (collectively known as 140) before generating the final image 150A, 150B (collectively known as 150) that meets the predetermined constraints 120. The initial image 130 may be in any suitable format, such as in two-dimensional format, a three-dimensional format, and/or an audio format. The predetermined constraint 120 is a quantifiable or measurable characteristic of an object. As an example, in the case of the object being a vehicle, the predetermined constraint 120 may be a drag coefficient, a manufacturability criterion, a vehicle dimension, a vehicle structural strength, and/or a vehicle weight distribution.

As such, the diffusion model 110 is trained to identify pixels in an image 130, 140 and further determine pixel values of the pixels in the image 130, 140. The diffusion model 110 is trained to analyze an image 130, 140 and further determine whether the image 130, 140 meets a predetermined constraint 120. The diffusion model 110 is also trained to alter the pixel values of the pixels in the image 130, 140 such that the image 140 with the altered pixels is closer to meeting the predetermined constraint 120. The diffusion model 110 is also trained on real images as a regularizer.

As an example and as shown in FIG. 1A, the diffusion model 110 receives an initial image 130A, that includes a rectangle 135A. The diffusion model 110 receives a predetermined constraint 120A related to a drag coefficient, particularly, a maximum drag coefficient. The diffusion model 110 determines the pixel values of the pixels in the initial image 130A using any suitable method. The diffusion model 110 may then determine the drag coefficient value of the initial image 130A and compare the determined drag coefficient value to the maximum drag coefficient to determine the difference between the determined drag coefficient value to the maximum drag coefficient. The diffusion model 110 may then select one or more pixels in the initial image 130A to alter so that the resulting image is closer to meeting the maximum drag coefficient. As such and as shown in FIG. 1A, the diffusion model 110 may alter the pixel values of the selected pixels resulting in an intermediate image 140A. The intermediate image 140A is closer to meeting the predetermined constraint 120A by having a lower drag coefficient value than the initial image 130A. The diffusion model 110 may further alter the initial intermediate image 140A and cycle through multiple intermediate images 140A, incrementally lowering the drag coefficient value with each iteration until the predetermined constraint 120A is met. At that point, the diffusion model 110 outputs the intermediate image 140A that meets the predetermined constraint(s) 120A as the final image 150A. As such, the diffusion model 110 generates the final image 150A based on the initial image 130A and the predetermined constraint(s) 120A.

As another example and as shown in FIG. 1B, the diffusion model 110 receives an initial image 130B that includes a solid L-shaped bracket 135B. This is an example of topology optimization. The bracket 135B may be used as a component in a building structure or a vehicle structure. However, there may be a need to cap the weight of the bracket 135B without compromising the structure of the bracket 135B. As such, the diffusion model 110 receives a predetermined constraint 120B related to a weight requirement, particularly, a maximum weight requirement for the bracket 135B. The diffusion model 110 determines the pixel values of the pixels in the initial image 130B using any suitable method. The diffusion model 110 may then determine the weight of the bracket 135B and compare the determined weight to the maximum weight requirement to determine the difference between the weight of the bracket 135B and the maximum weight requirement. The diffusion model 110 may then select one or more pixels in the initial image 130B to alter so that the resulting image is closer to meeting the maximum weight requirement. As such and as shown in FIG. 1B, the diffusion model 110 may alter the pixel values of the selected pixels resulting in an intermediate image 140B, where portions of the bracket 135B have been removed, making for a bracket that is of less weight than the bracket 135B in the initial image 130B. As such, the intermediate image 140B is closer to meeting the predetermined constraint 120B by having a lower weight than the initial image 130B. The diffusion model 110 may cycle through multiple intermediate images 140B, incrementally lowering the weight of the bracket 135B with each iteration until the predetermined constraint 120B is met. At that point, the diffusion model 110 outputs the intermediate image 140B that meets the predetermined constraint 120B as the final image 150B. As such, the diffusion model 110 generates the final image 150B based on the initial image 130B and the predetermined constraint 120B after one or more iterations. In other words and as an example, the diffusion model 110 generates each subsequent intermediate image 140 based on Imageₜ₊₁=Image(+f(Imageₜ), where the f(Imageₜ) is a domain-specific penalty term corresponding to the optimization objective.

To further explain the predetermined constraints 120, a manufacturability criterion refers to factors to be considered during the manufacturing process of the object represented by the image 130, 140. As an example, a manufacturability criterion may be the time in which the object is to be produced, the amount of computer and/or power resources available to produce the object, and/or the amount of material required to produce the object. The diffusion model 110 may receive one or more manufacturability criteria. The manufacturability criteria may be based on a checklist of various factors that affect the manufacturing process of the object.

The diffusion model 110 may apply any suitable method or formula to determine whether the object represented by the image 130, 140 can be produced within the provided manufacturability criteria. As an example, the diffusion model 110 may determine the time in which the object represented by the image 130, 140 would be produced based on the size and shape of the image 130, 140. In the case that the object represented by the image 130, 140 cannot be produced within the provided manufacturability criteria, the diffusion model 110 may alter the image 130, 140, as previously mentioned, to generate the intermediate image 140 that may be closer to meeting the manufacturability criteria.

As an example of the predetermined constraint 120 being a vehicle dimension, the diffusion model 110 may receive a minimum or maximum vehicle dimension. The vehicle dimension may be related to the whole vehicle or a portion of the vehicle such as the wheel of the vehicle, the body of the vehicle, the window(s) of the vehicle, the front hood of the vehicle, the trunk of the vehicle, and/or a bracket in the vehicle, as previously mentioned. The diffusion model 110 may receive one or more vehicle dimensions. The diffusion model 110 may apply any suitable method or formula to determine whether the object represented by the image 130, 140 meets the vehicle dimension(s). In the case that the object represented by the image 130, 140 does not meet the vehicle dimension(s), the diffusion model 110 may alter the image 130, 140, as previously mentioned, to generate the intermediate image 140 that may be closer to meeting the vehicle dimensions.

As an example of the predetermined constraint 120 being a vehicle structural strength, the diffusion model 110 may receive any suitable vehicle structural strength values such as a strength-to-weight ratio. The diffusion model 110 may apply any suitable method or formula to determine whether the object represented by the image 130, 140 meets the vehicle structural strength value(s). In the case that the object represented by the image 130, 140 does not meet the vehicle structural strength value(s), the diffusion model 110 may alter the image 130, 140, as previously mentioned, to generate the intermediate image 140 that may be closer to meeting the vehicle structural strength value(s).

As an example of the predetermined constraint 120 being a vehicle weight distribution, the diffusion model 110 may receive a vehicle weight distribution ratio, referring to the distribution of the weight of the vehicle on the wheels of the vehicle. As an example, the vehicle weight distribution ratio may be a ratio of 50-50, such that 50 percent of the weight of the vehicle is on the front wheels and 50 percent of the weight of the vehicle is on the rear wheels. The diffusion model 110 may apply any suitable method or formula to determine whether the object represented by the image 130, 140 meets the vehicle weight distribution ratio. In the case that the object represented by the image 130, 140 does not meet the vehicle weight distribution ratio, the diffusion model 110 may alter the image 130, 140, as previously mentioned, to generate the intermediate image 140 that may be closer to meeting the vehicle weight distribution ratio.

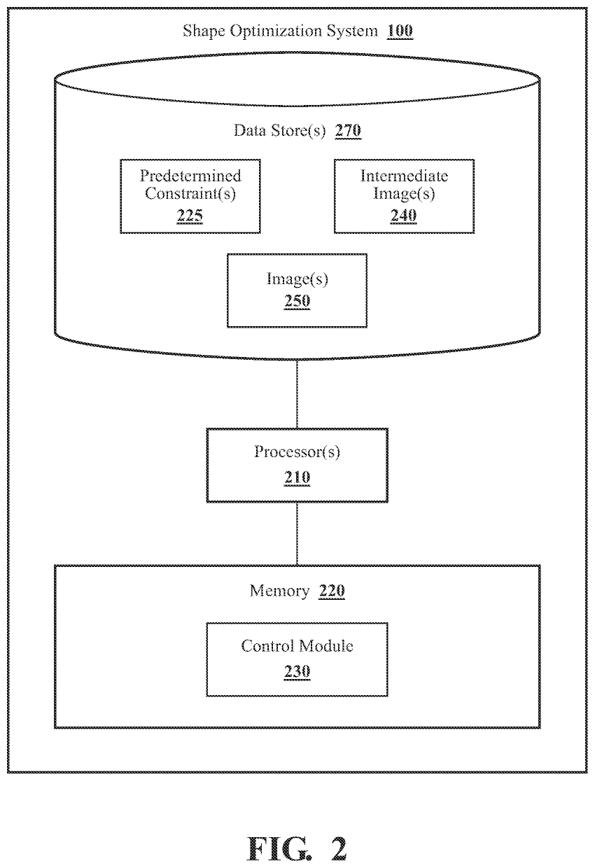

With reference to FIG. 2, one embodiment of the shape optimization system 100 of FIG. 1 is further illustrated. The shape optimization system 100 is shown as including a processor 210. Accordingly, the processor 210 may be a part of the shape optimization system 100, or the shape optimization system 100 may access the processor 210 through a data bus or another communication path. In one or more embodiments, the processor 210 is an application-specific integrated circuit (ASIC) that is configured to implement functions associated with a control module 230. In general, the processor 210 is an electronic processor, such as a microprocessor, that is capable of performing various functions as described herein.

In one embodiment, the shape optimization system 100 includes a memory 220 that stores the control module 230 and/or other modules that may function in support of shape optimization. The memory 220 is a random-access memory (RAM), read-only memory (ROM), a hard disk drive, a flash memory, or another suitable memory for storing the control module 230. The control module 230 is, for example, machine-readable instructions that, when executed by the processor 210, cause the processor 210 to perform the various functions disclosed herein. In further arrangements, the control module 230 is a logic, integrated circuit, or another device for performing the noted functions that includes the instructions integrated therein.

Furthermore, in one embodiment, the shape optimization system 100 includes a data store 270. The data store 270 is, in one arrangement, an electronic data structure stored in the memory 220 or another data store, and that is configured with routines that can be executed by the processor 210 for analyzing stored data, providing stored data, organizing stored data, and so on. Thus, in one embodiment, the data store 270 stores data used by the control module 230 in executing various functions.

For example, as depicted in FIG. 2, the data store 270 includes the images 250, the intermediate images 240, and the predetermined constraints 225, along with, for example, other information that is used and/or produced by the control module 230. The images 250 may include the images 150 generated by the diffusion model 110. The intermediate images 240 may include the intermediate images 140 generated by the diffusion model 110. The predetermined constraints 225 may be generated and/or entered using any suitable means such as by a user. The predetermined constraints 225 may include the predetermined constraints 120 being received by the diffusion model 110.

While the shape optimization system 100 is illustrated as including the various data elements, it should be appreciated that one or more of the illustrated data elements may not be included within the data store 270 in various implementations and may be included in a data store that is external to the shape optimization system 100. In any case, the shape optimization system 100 stores various data elements in the data store 270 to support functions of the control module 230.

In one embodiment, the control module 230 includes instructions that, when executed by the processor(s) 210, cause the processor(s) 210 to optimize a parameter of a shape in an image 130, 140 based on a predetermined constraint using a diffusion model 110. The parameter being a pixel value for each pixel forming the shape. As an example, the pixel value may range from 0 (black) to 255 (white). As another example, the pixel value may be binary with the pixel value being off (black) or on (white).

In one embodiment, the control module 230 includes instructions that, when executed by the processor(s) 210, cause the processor(s) 210 to optimize the parameter of the shape based on a plurality of images. As such, the control module 230 may feed one or more images 130 and one or more predetermined constraints 120 to the diffusion model 110. The diffusion model 110 may optimize the parameter of the shape based on the predetermined constraint(s) as previously described. The predetermined constraint may be a drag coefficient, a manufacturability criterion, a vehicle dimension, a vehicle structural strength, and/or a vehicle weight distribution. More generally, the predetermined constraint may be a dimension, a weight, a structural strength value, and/or a weight distribution.

In one embodiment, the control module 230 includes instructions that, when executed by the processor(s)210, cause the processor(s) 210 to optimize the parameter of the shape in image space. As such, the diffusion model 110 processes the image(s) 130 as an image comprising of pixels, each with a pixel value, and the diffusion model 110 may optimize the parameter of the shape by altering the pixel values.

In one embodiment, the control module 230 includes instructions that, when executed by the processor(s) 210, cause the processor(s) 210 to train the diffusion model on real images as a regularizer. In one embodiment, the control module 230 includes instructions that, when executed by the processor(s) 210, cause the processor(s) 210 to optimize the parameter of the shape by constraining the pixel values such that the image appears to be a real image. As previously mentioned, the diffusion model 110 may be trained on real images as a regularizer. As such, the diffusion model 110 may optimize the parameter(s) of the shape by constraining the pixel values such that the image appears to be a real image.

In one embodiment, the control module 230 includes instructions that, when executed by the processor(s) 210, cause the processor(s) 210 to generate the image using the diffusion model. In such a case, the diffusion model 110 may optimize the parameter of the shape of an initial image 130 based on the predetermined constraint(s) 120 and generate an output image 150 that meets the predetermined constraint(s).

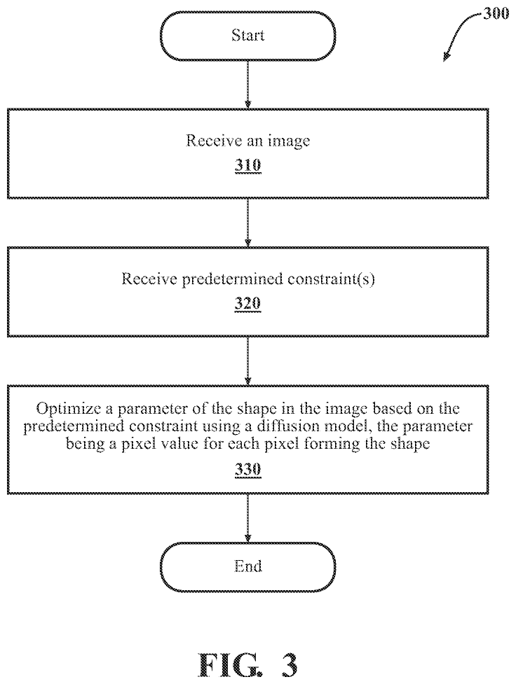

FIG. 3 is a flowchart illustrating one embodiment of a method 300 associated with shape optimization. The method 300 will be described from the viewpoint of the shape optimization system 100 of FIGS. 1-2. However, the method 300 may be adapted to be executed in any one of several different situations and not necessarily by the shape optimization system 100 of FIGS. 1-2.

At step 310, the control module 230 may cause the processor(s) 210 to receive the image(s) 130. The control module 230 may feed the image(s) 130 to the diffusion model 110.

At step 320, the control module 230 may cause the processor(s) 210 to receive predetermined constraint(s) 120. The control module 230 may feed the predetermined constraint(s) 120 to the diffusion model 110.

At step 330, the control module 230 may cause the processor(s) 210 to optimize a parameter of a shape in the image 130 based on the predetermined constraint(s) 120 using a diffusion model. The diffusion model 110 may optimize the parameter by altering the value of a portion of the pixels in the image 130 using any suitable method.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in the figures but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Generally, modules, as used herein, include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system comprising:
a processor; and
a memory storing machine-readable instructions that, when executed by the processor, cause the processor to:
optimize a parameter of a shape in an image based on a predetermined constraint using a diffusion model, the parameter being a pixel value for each pixel forming the shape.

2. The system of claim 1, wherein the machine-readable instructions further include instructions that when executed by the processor cause the processor to:
optimize the parameter of the shape by constraining the pixel values such that the image appears to be a real image.

3. The system of claim 1, wherein the machine-readable instructions further include instructions that when executed by the processor cause the processor to:
optimize the parameter of the shape in image space.

4. The system of claim 1, wherein the machine-readable instructions further include instructions that when executed by the processor cause the processor to:
generate the image using the diffusion model.

5. The system of claim 1, wherein the predetermined constraint is based on one of:
a drag coefficient;
a manufacturability criterion;
a vehicle dimension;
a vehicle structural strength; or
a vehicle weight distribution.

6. The system of claim 1, wherein the machine-readable instructions further include instructions that when executed by the processor cause the processor to:
optimize the parameter of the shape based on a plurality of images.

7. The system of claim 1, wherein the machine-readable instructions further include instructions that when executed by the processor cause the processor to:
train the diffusion model on real images as a regularizer.

8. A method comprising:
optimizing a parameter of a shape in an image based on a predetermined constraint using a diffusion model, the parameter being a pixel value for each pixel forming the shape.

9. The method of claim 8, further comprising:
optimizing the parameter of the shape by constraining the pixel values such that the image appears to be a real image.

10. The method of claim 8, further comprising:
optimizing the parameter of the shape in image space.

11. The method of claim 8, further comprising:
generating the image using the diffusion model.

12. The method of claim 8, wherein the predetermined constraint is based on one of:
a drag coefficient;
a manufacturability criterion;
a vehicle dimension;
a vehicle structural strength; or
a vehicle weight distribution.

13. The method of claim 8, further comprising:
optimizing the parameter of the shape based on a plurality of images.

14. The method of claim 8, further comprising:
training the diffusion model on real images as a regularizer.

15. A non-transitory computer-readable medium including instructions that when executed by a processor cause the processor to:
optimize a parameter of a shape in an image based on a predetermined constraint using a diffusion model, the parameter being a pixel value for each pixel forming the shape.

16. The non-transitory computer-readable medium of claim 15, wherein the instructions further include instructions that when executed by the processor cause the processor to:
optimize the parameter of the shape by constraining the pixel values such that the image appears to be a real image.

17. The non-transitory computer-readable medium of claim 15, wherein the instructions further include instructions that when executed by the processor cause the processor to:
optimize the parameter of the shape in image space.

18. The non-transitory computer-readable medium of claim 15, wherein the instructions further include instructions that when executed by the processor cause the processor to:
generate the image using the diffusion model.

19. The non-transitory computer-readable medium of claim 15, wherein the predetermined constraint is based on one of:
a drag coefficient,
a manufacturability criterion,
a vehicle dimension,
a vehicle structural strength, or
a vehicle weight distribution.

20. The non-transitory computer-readable medium of claim 15, wherein the instructions further include instructions that when executed by the processor cause the processor to:
optimize the parameter of the shape based on a plurality of images.
